(19) United States
(12) Patent Application Publication
(10) Pub. No.: US 2006/0011686 A1
(43) Pub. Date: Jan. 19, 2006

(54) Container for holding items in a vehicle

(76) Inventor: Teresa Lynn Latham, Los Angeles, CA (US)

Correspondence Address: COHEN SAKAGUCHI & ENGLISH LLP, 2040 MAIN STREET, 9TH FLOOR, IRVINE, CA, 92614, US

(21) Appl. No.: 10/894,842

(22) Filed: Jul. 19, 2004

(51) Int. Cl. A45C 15/00; B60R 7/00; B65D 25/04

(52) U.S. Cl. 224/579; 224/585; 224/275; 224/572; 383/38; 190/102; 190/109; 220/529

(57) ABSTRACT

A container for securing objects in a moving vehicle comprises a bottom panel and a sidewall attached to and extending upwardly from the bottom panel to form a box-like structure forming a first container portion. The sidewall may be foldably attached to the bottom panel such that the container may be collapsed down so that it is more compact for easy storage. The sidewall may be comprised of a plurality of walls each attached to the bottom panel or alternatively, the sidewall may be formed by a single, integral structure attached to the bottom panel. The sidewall may be collapsible such that the sidewall may be folded or crumpled down relatively flat over the bottom panel. The container includes an adjustable divider disposed in the container which partitions the interior of the container. A variety of other accessories, such as drink holders, shelves, tables, and pockets may also be disposed in, or on, the container to conveniently hold objects in a moving vehicle.

### FIELD OF THE INVENTION

The present invention relates generally to containers and more particularly to a container for holding items in a vehicle.

### BACKGROUND OF THE INVENTION

Transporting objects in vehicles, such as a car, truck, bus or boat, can often be awkward and difficult. For example, transporting objects such as food containers, drinks or containers of fluids or small knick-knacks can be especially difficult. Moreover, the seats of most vehicles are designed to accommodate a seated person and are typically not flat or level. Similarly, the floor of such vehicles are also not flat or level. If not secured, the containers are unstable and tend to slide, tip, fall, or otherwise move about when the vehicle is in motion. The moving, tipping or falling of the objects can damage the objects or cause containers to spill their contents. This creates a driving hazard in addition to making a mess of the vehicle.

Several containers for holding objects in a moving vehicle have been previously described. For example, a vehicle desk container is described in U.S. Pat. No. 4,619,386, issued Oct. 28, 1986, to Richardson. The vehicle desk container comprises a rectangular box with a top lid attached to the box by hinges. The container has built-in desk accessories such as a clock, pencil sharpener and light. A plurality of fixed partitions may be inside the box to provide individual storage compartments. Finally, the container has one or more straps to secure the container to a seat or other part of the vehicle. A major drawback to this desk container is that it is too small to hold anything but small desk or office accessories like pens, pencils, calculators or erasers. In addition, the desk container does not have any device which is adjustable for securely holding objects of varying sizes. The partitions in this vehicle desk container are fixed in both size and location. Another problem with this vehicle desk container is that it cannot be folded or collapsed for storage when not in use.

Accordingly, there is a need for a device which can secure objects in a moving vehicle. The device should be portable and easily adjustable to accommodate objects of varying sizes and shapes. The device should also have a convenient apparatus for securing the device to a part of the vehicle.

### SUMMARY OF THE INVENTION

The container of the present invention is well-suited for securely transporting objects of varying sizes and shapes in a moving vehicle. The container comprises a bottom panel and a sidewall attached to and extending upwardly from the bottom panel to form a box-like structure forming a first container portion. The sidewall may be foldably attached to the bottom panel such that the container may be collapsed down so that it is more compact for easy storage. The bottom panel may be of any suitable shape such as a circle, rectangle, square, other polygon, etc. The sidewall comprises an inside surface and an outside surface. The sidewall may be comprised of a plurality of walls each attached to the bottom panel or alternatively, the sidewall may be formed by a single, integral structure attached to the bottom panel.

In the case where a plurality of walls is used, each wall forms a section of the sidewall. Each wall has an inside surface, an outside surface and an edge around its perimeter. Each wall also has a plurality of wall fasteners along at least a portion of the edge of the wall for removably coupling the edge of the wall to at least a portion of the edge of an adjoining wall. In the assembled, or uncollapsed, configuration of the container, the plurality of walls extend upwardly from the bottom panel and the side edges of the walls are attached to each other using the wall fasteners. In the collapsed configuration of the container, the side edges of the walls are unfastened and are folded down over the bottom panel.

In the case of a single, integral sidewall, the sidewall comprises a plurality of bendable, foldable, or otherwise deformable supports which hold the sidewall in the extended position when the container is in the assembled, or uncollapsed, configuration. The sidewall is made of a flexible material, such as nylon. To collapse the container, the supports and the sidewall are folded or crumpled down over the bottom panel. A strap or fastener may be used to retain the sidewall in the collapsed position.

An adjustable divider is disposed in the container which divides the first container portion into second and third container portions. The divider may be made of a flexible material such that it can form to the shape of an object being secured within the container. A plurality of divider fasteners are disposed on the inside surface of the sidewall for being removably attached to said divider. The divider fasteners are arranged on the inside surface of the sidewall such that the divider may be adjusted to a plurality of positions within the first container portion. In this way, the size and/or shape of the second and third container portions may be adjusted by moving the adjustable divider. Moreover, one or more additional adjustable dividers may be used in order to further partition the first container portion. The additional adjustable divider may be attachable to the sidewall, or to one of the other dividers or to both.

### BRIEF DESCRIPTION OF THE DRAWINGS

FIG. 1 is a front perspective view of a container according to the present invention.

FIG. 2 is a rear perspective view of the container of FIG. 1 with the top panel in the closed position.

FIG. 3 is a front view of the divider of the container of FIG. 1.

FIG. 4 is a back view of the divider of the container of FIG. 1.

FIG. 5 is a front view of a divider for use in a container according to the present invention.

FIG. 6 is a back view of the divider of FIG. 5.

FIG. 7 is a perspective view of a drink holder accessory according to the present invention.

FIG. 8 is a front perspective view of a hanging pocket according to the present invention.

FIG. 9 is a rear perspective view of a container according to the present invention.

FIG. 10 is a top view of the container of FIG. 9 in a disassembled and unfolded configuration.

FIG. 11 is a perspective view of the container of FIG. 9 in a fully assembled configuration.

FIG. 12 is a bottom perspective view of a container according to the present invention.

FIG. 13 is a top perspective view of the container of FIG. 12.

FIG. 14 is a top perspective view of a container according to the present invention with a desk attachment inserted therein.

FIG. 15 is top perspective view of the desk attachment shown inserted into the container of FIG. 14.

FIG. 16 is a top view of a container according to the present invention in a disassembled configuration.

FIG. 17 is a perspective view of the container of FIG. 16 in a fully assembled configuration.

FIG. 18 is a perspective view of a container according to the present invention with the straps arranged for use as a handle for carrying the container.

FIG. 19 is a front perspective view of a hanging board according to the present invention.

FIG. 20 is a rear perspective view of a removable pouch according to the present invention.

FIG. 21 is a perspective view of a container with a hanging board and removable pouch attached to the container according to the present invention.

FIG. 22 is a perspective view of a table accessory according to the present invention.

FIG. 23 is a perspective view of a container having the table accessory of FIG. 22 assembled therein.

### DETAILED DESCRIPTION OF THE INVENTION

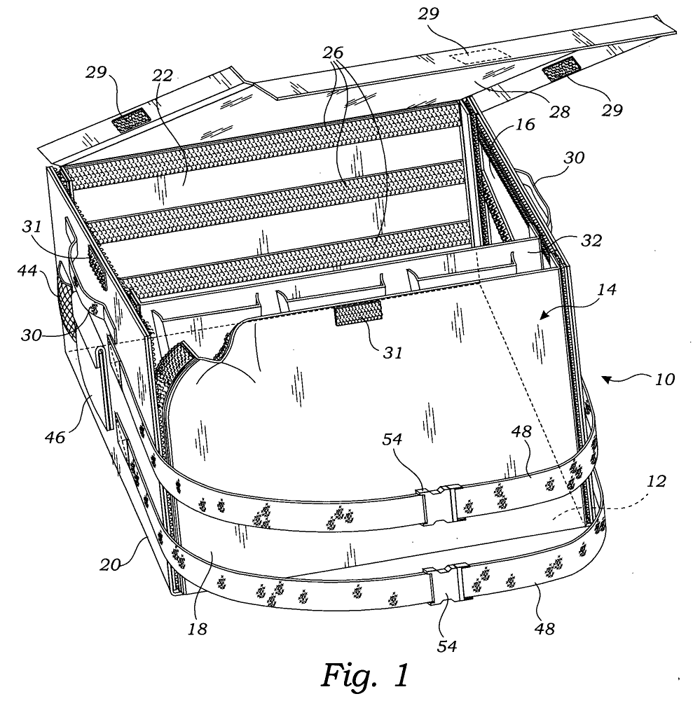

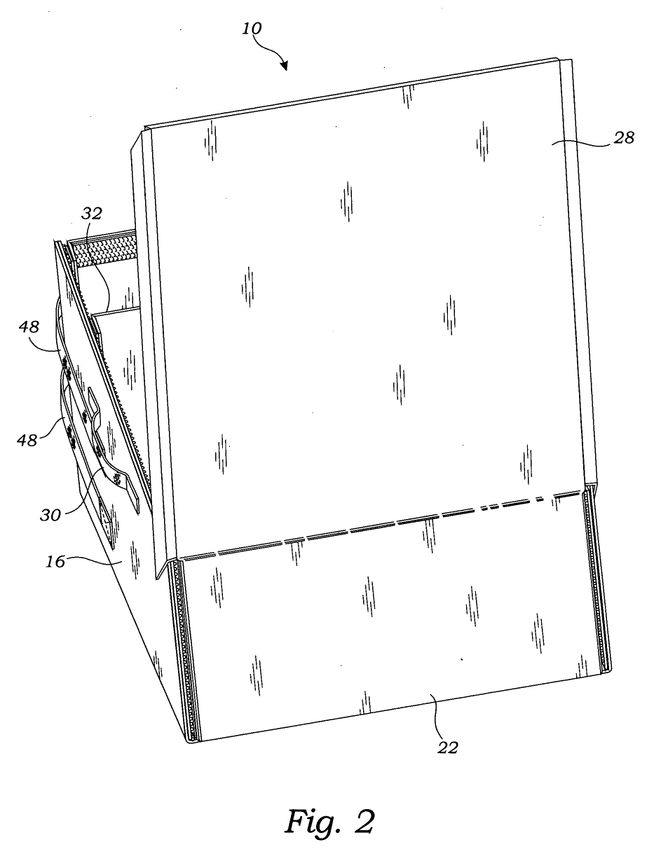

Turning to FIGS. 1 and 2, a container 10 according to the present invention is shown. The container 10 comprises a bottom panel 12 and a sidewall 14 attached to and extending upward from the bottom panel. The bottom panel 12 may be flat and is preferably semi-rigid, rigid, pliable or flexible. It may be made of two or more sheets of nylon material having a stiffening plate between the sheets of nylon. The plate may be made of most plastics, foam or other suitable material which provides the desired rigidity or pliability to the sidewall 14. While the bottom panel 12 is shown as rectangular, other shapes and sizes may be utilized in order to provide the desired design. For example, the bottom panel 12 may be in the shape of a square, other polygon, circle or other random shape.

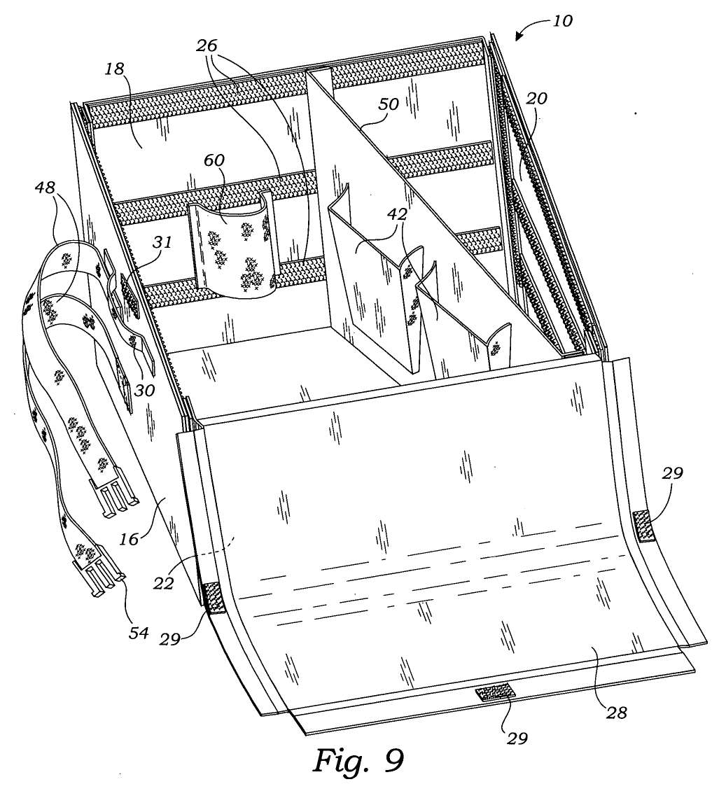

The sidewall 14 has four walls including a right wall 16, a front wall 18, a left wall 20 and a back wall 22. The sidewall 14 and the bottom panel 12 form a rectangular box. The sidewall 14 may be a single, integral structure, or alternatively, it may be formed of two or more separate panels. The inside surface 24 of the sidewall 14 has three strips of hook and loop fasteners 26 which may extend around all four walls 16, 18, 20 and 22. The four walls 16, 18, 20 and 22 may be of uniform height or differing heights such that the plane formed by the top surface of the walls is at an angle from the plane formed by the bottom panel 12. As an example, in the container 10 of FIG. 9, the front wall 18 is shorter than the back wall 22. In that case, the right wall 16 and the left wall 20 have a varying height from the back to the front. In other words, the top edge of the right wall 16 and left wall 20 slope from back to front so that they have the same height as the back wall 22 at the intersection with the back wall 22 and the same height as the front wall 18 at the intersection with the front wall 18.

Referring to FIG. 2, the container 10 may have a top cover 28 which is foldably attached to the top edge of a portion of the sidewall 14. The top cover 28 may cover a portion or all of the open top of the container 10 to provide an enclosed space within the container 10. The top cover may have a plurality of fasteners 29 which attach to fasteners 31 on the sidewall 14. The fasteners 29 and 30 may be snaps, buttons, hook and loop fasteners or other suitable fasteners. Two handles 30 are attached to the outside surface of two opposing walls 16 and 20 to facilitate carrying of the container 10. A cellular phone holder 44 and a storage pocket 46 are also attached to the outside surface of the sidewall 14.

A pair of straps 48 are attached to the outside surface of the sidewall 14. The straps are used to secure the container 10 to a vehicle seat or other vehicle part, like a seatbelt or console. The straps 14 have a releasable buckle or clasp 54 so that the straps 14 can be separated in order to loop the straps 14 around a seat or other vehicle part and then reconnect the buckles 54. The length of the straps 14 is preferably adjustable. The buckles may be replaced by any other suitable fastener such as snaps, buttons or hook and loop fasteners. The straps 48 may also be arranged for use as a handle to carry the container as shown in FIG. 18.

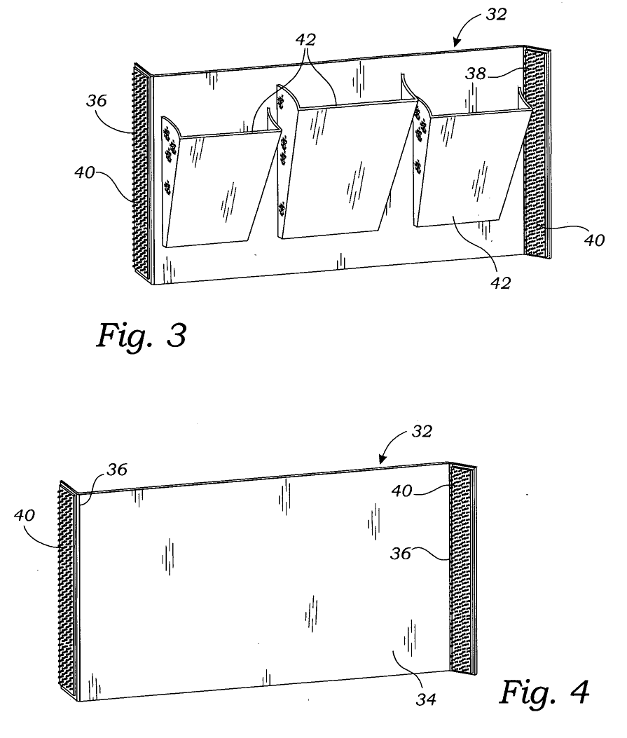

An adjustable divider 32 may be inserted into the container 10 to partition the interior space of the container 10. Referring to FIGS. 3 and 4, the divider 32 comprises a flat panel 34 having a first side edge 36 and a second side edge 38. The first and second side edges 36 and 38 each have a strip of hook and loop fasteners 40 which may be removably attached to the strips of hook and loop fasteners 26 on the inside surface of the sidewall 14. The hook and loop fasteners 40 may be foldably attached to the first and second side edges 36 and 38 of the divider 32 so that they can be aligned to effectively attach to the hook and loop fasteners 26. The foldability of the fasteners 40 may be accomplished by disposing the fasteners on a flexible flap of material which extends from the edge of the flat panel 34. The divider 32 may have a length so that it extends from front wall 18 to back wall 22 (see FIG. 9) or from right wall 16 to left wall 18 (see FIG. 1) or between any two adjacent walls, such as between right wall 16 and back wall 22. The divider 32 may be extendable so that its length can be adjusted so that the divider can be positioned and oriented to partition the interior of the container 10 to the desired shape and size. The divider 32 has several pockets 42 of varying sizes for holding objects. For example, one of the pockets 42 may be shaped and sized to hold a soft drink container, a calculator, a pen or pencil, or cellular phone.

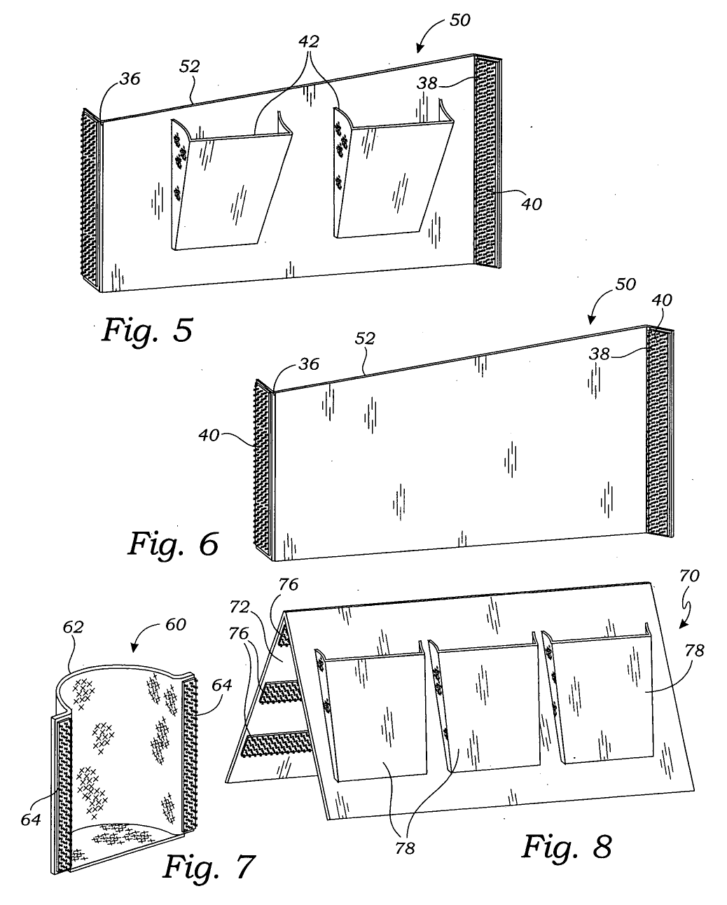

Referring to FIGS. 5 and 6, an alternative adjustable divider 50 is shown which is especially useful with a container 10 where one of the walls 16, 18, 20 or 22 is shorter than the opposing wall, as described above. The divider 50 is the same as the divider 32 shown in FIGS. 3 and 4, except that the top edge 52 of the divider 50 is sloped, and like reference numerals refer to like elements. The divider 50 is used just like the divider 32, described above.

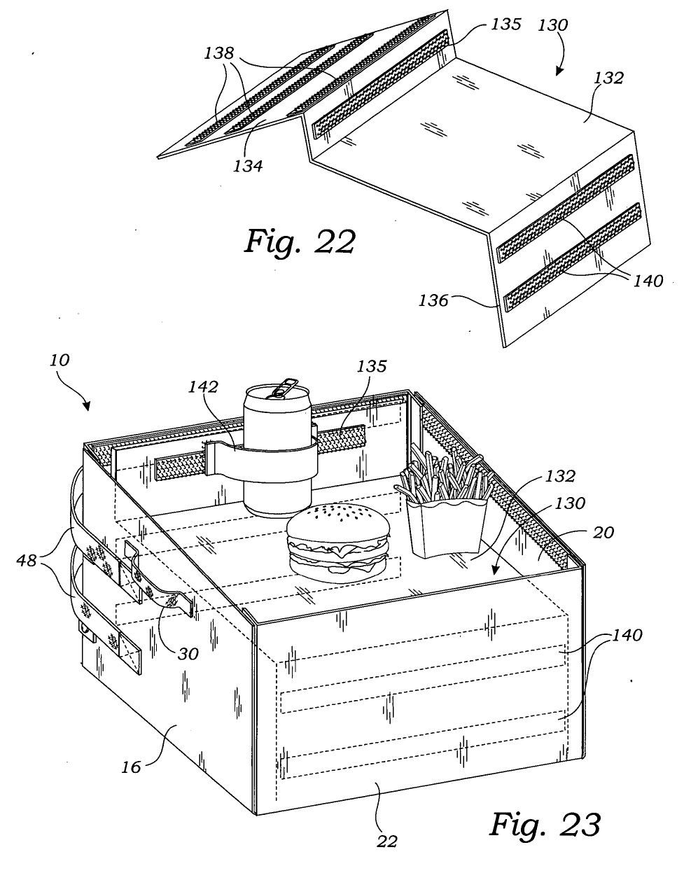

A table accessory 130 is shown in FIGS. 22-23. The table accessory comprises a table top 132 and two hanging panels 134 and 136 foldably attached to the table top 132. The hanging panel 134 comprises a folded panel having three strips of hook and loop fasteners 138 on the back side. The hanging panel 136 has two strips of hook and loop fasteners 140 on the front side. Another strip of hook and loop fasteners 135 may be provided for attaching other accessories to the table accessory 130, as described below. The table accessory 130 is installed in the container 10 by inserting the table accessory 130 into the container 10 and attaching the fasteners 138 and 140 to the fasteners 26. A cup holder 142 having hook and loop fasteners may be attached to the fastener 135 for holding a drink on the table accessory. The table accessory 130 provides a storage surface that is nearer the top of the container 10 and is particularly handy for storing items that the user wants convenient access to while driving, such as food or drinks.

A horizontal shelf divider, similar to the table accessory 130, may also be used in the container 10 to divide the container 10 into multiple compartments with one above the other, similar to that shown in FIG. 23. The shelf divider comprises a flat panel and four edges. Two or more of the edges each have a strip of hook and loop fasteners which are removably attachable to the strips of hook and loop fasteners 26 on the inside surface of the sidewall 14. The hook and loop fasteners 116 may be foldably attached to the side edges 114 so that they can be aligned to effectively attach to the hook and loop fasteners 26. The foldability of the fasteners may be accomplished by disposing the fasteners on a flexible flap of material which extends from the edges. The shelf may have a length and width so that extends across the entire container 10 or the shelf may be extendable so that its length can be adjusted so that the shelf can cover just a portion of the container 10. In use, an object can be placed onto the bottom panel 12 and then the shelf 110 can be inserted into the container 10 over the object. The shelf is then attached in place by fastening the fasteners to the fasteners. Then, objects can be placed onto the shelf. Dividers such as the dividers 32 and 50, described above can also be used along with the shelf, so long as the dividers have shorter heights so that they extend from the height of the shelf 10 to the top of the sidewall 14.

FIG. 7 shows a cup holder 60 accessory that may be used with the container 10. The cup holder 60 comprises a receptacle 62 which is sized and shaped to hold a drink container. The receptacle 62 may have a size and shape to hold any desired drink container, including but not limited to a typical twelve ounce soda can, a cup of coffee or a super-sized drink container. Two strips of hook and loop fasteners 64 are disposed on opposite sides of the receptacle 62. The cup holder 60 may be attached to any of the hook and loop fasteners of the container 10. For example, the cup holder 60 may be attached to the hook and loop fasteners 26 on the inside surface of the sidewall 14, as shown in FIG. 9.

Another accessory for the container 10 is shown in FIG. 8. The hanging pocket 70 comprises a first panel 72 and a second panel 74 which are foldably connected to each other along an edge of each panel. The first panel 72 has three strips of hook and loop fasteners 76 on the inside surface of the first panel 72. The second panel 74 has a plurality of pockets 78 on the outside surface of the second panel 74. The hanging pocket board 70 is used by hanging it over the edge of one of the walls 16, 18, 20 or 22 with the first panel 72 on the inside the container 10 and the second panel 74 on the outside of the container 10. The hook and loop fasteners 76 are removably attached to the hook and loop fasteners 26 on the inside surface of the sidewall 14. The pockets 78 are then accessible on the outside of container 10 so that items may be easily stored and retrieved.

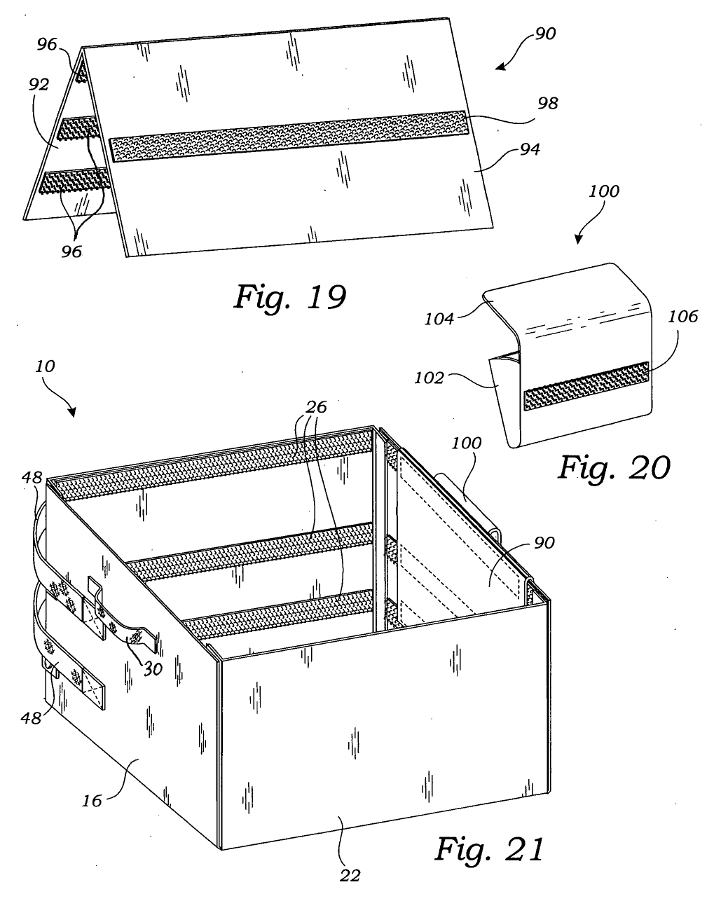

Referring to FIGS. 19-21, another accessory which is similar to the hanging pocket 70 is shown. The hanging board 90 comprises a first panel 92 and a second panel 94 which are foldably connected to each other along an edge of each panel. The first panel 92 has three strips of hook and loop fasteners 96 on the inside surface of the first panel 92. The second panel 94 has at least on strip of hook and loop fasteners 98 on the outside surface of the second panel 94. The hanger board 90 is used by hanging it over the edge of one of the walls 16, 18, 20 or 22 with the first panel 92 on the inside the container 10 and the second panel 94 on the outside of the container 10. The hook and loop fasteners 96 are removably attached to the hook and loop fasteners 26 on the inside surface of the sidewall 14. The hook and loop fasteners 98 are then accessible on the outside of container 10 where items having hook and loop fasteners, such as the drink holder 60 described above, may be removably attached. In addition, the removable pouch 100 shown in FIGS. 20 and 21 may be attached to the hanger board 90. The removable pouch 100 has a pocket portion 102 and a cover 104. The front of the pocket portion 102 has a fastener 106, preferably velcro™, and the cover 104 has a mating fastener, also preferably velcro™, to detachably hold the cover 104 in the closed position.

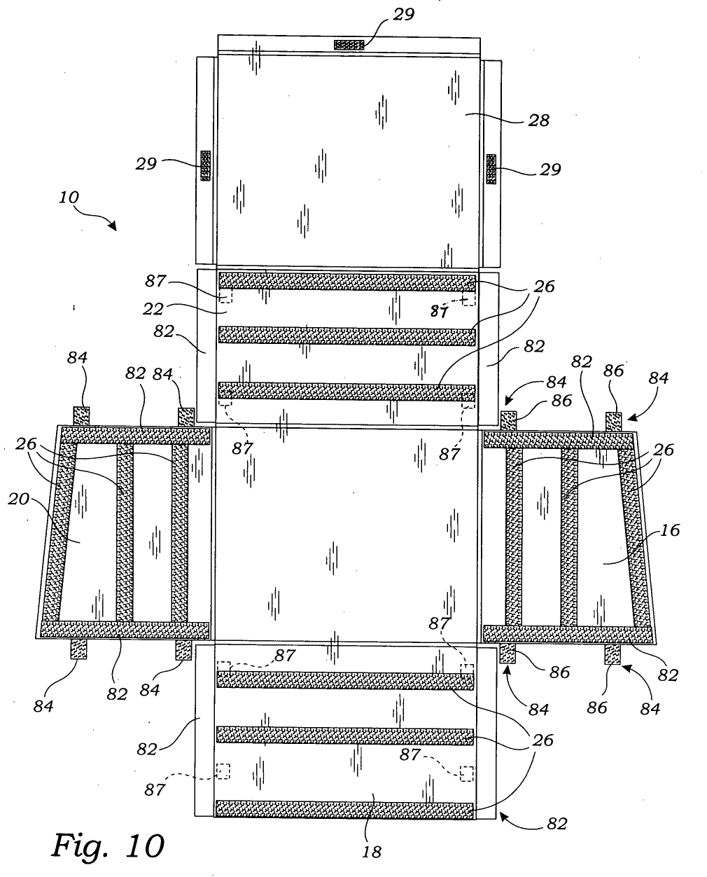

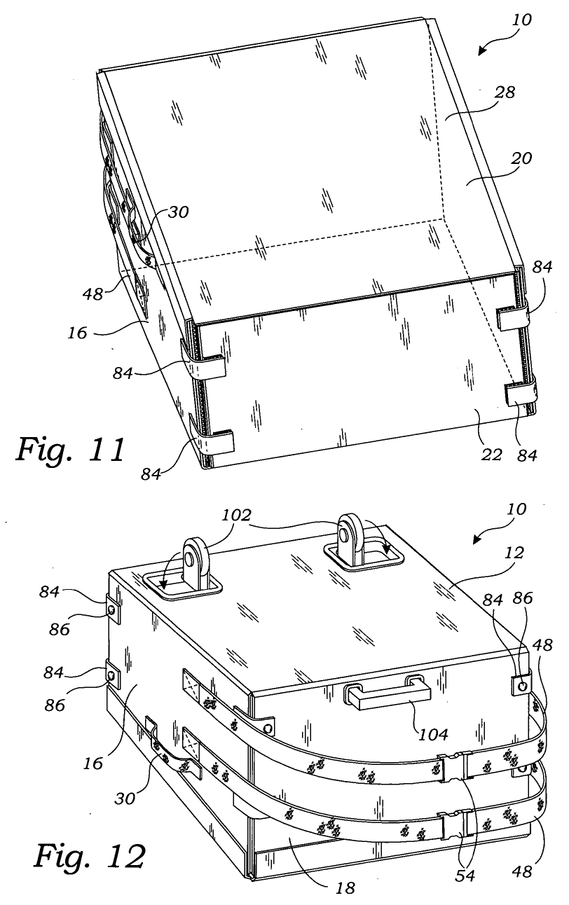

In another particularly innovative aspect of the present invention, the container of the present invention may have foldable walls 16, 18, 20 and 22 so that the container 10 is collapsible. Turning to FIGS. 10 and 11, the container 10 is similar to the container 10 shown in FIGS. 1 and 2 except for the addition of several straps 84 which help hold the container 10 in its assembled configuration. Again, like reference numerals in FIGS. 10 and 11 refer to like reference numerals used in the FIGS. 1-8. FIG. 10 shows the container 10 in a disassembled configuration with the walls 16, 18, 20 and 22 detached from the respective adjoining walls, while FIG. 11 shows the container 10 in an assembled configuration.

Each of the foldable walls 16, 18, 20 and 22 has a strip of hook and loop fasteners 82 along both of the side edges of each wall. The fasteners 82 along the edge of one wall connect to the fasteners along the adjacent edge of the adjoining wall, the two adjacent edges forming a connecting pair of edges. In order to align the fasteners 82 in each connecting pair of edges, at least one edge of each pair may be foldably attached to the edge of the wall by disposing the fasteners on a flexible flap of material. Alternatively, one of the edges of each connecting pair of edges may be angled substantially perpendicular to the wall so that it aligns with the adjacent edge to which it attaches. In the embodiment shown in FIGS. 10 and 11, walls 18 and 22 have flexible flaps with fasteners 82 along both side edges of each wall. Walls 16 and 20 have straps 84 attached at, or near, both side edges of each wall. The straps 84 may be fixedly attached to walls 16 and 20 using adhesive, thread or other suitable means, or they may be removably attached using snaps, velcro™, or buttons. The loose end of each strap 84 as shown in FIG. 10 has a fastener 86 which removable attaches to a mating fastener on the respective adjoining wall. The fasteners 86 may be snaps, buttons, velcro™ or other suitable removable fastening system. The fasteners 86 may attach to a mating fastener 87 provided on the adjoining wall.

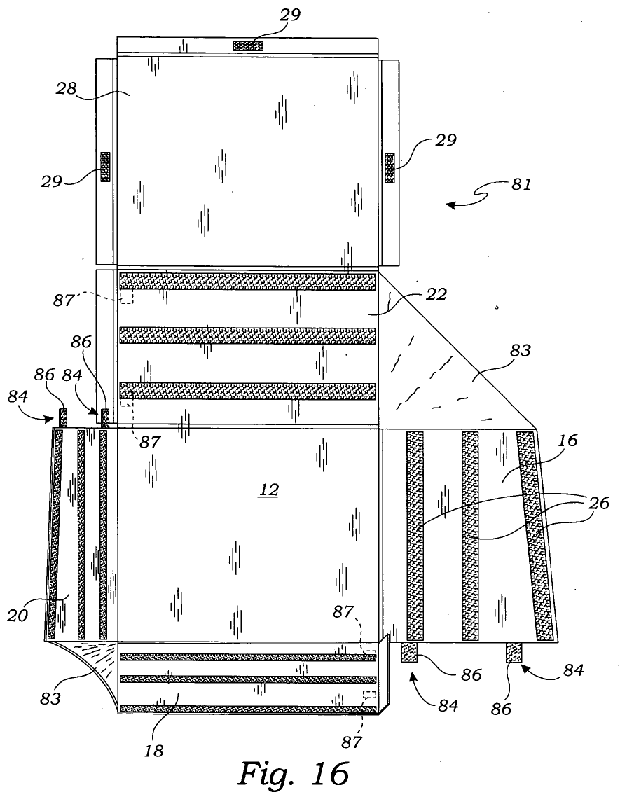

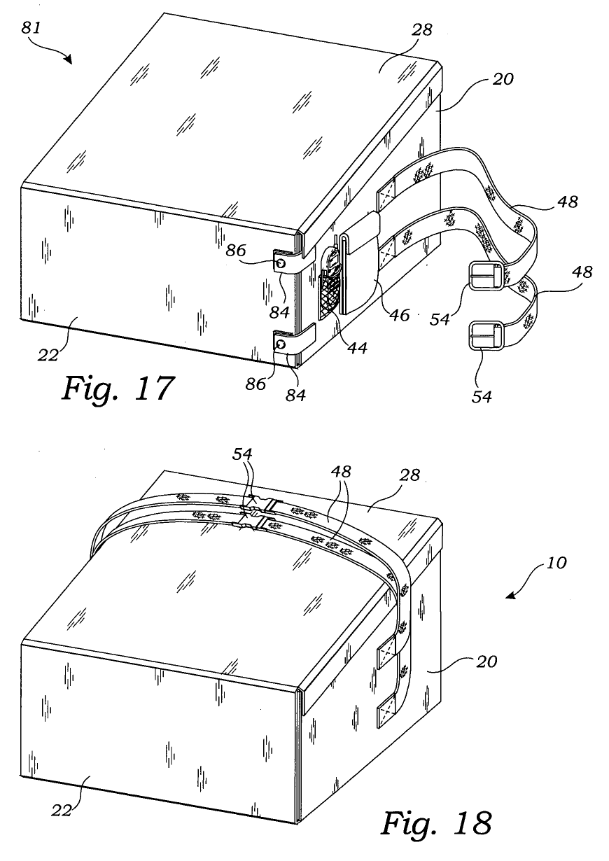

Referring to FIGS. 16-17, another embodiment of the container with foldable walls is shown. This container 81 is the same as the container 10 shown in FIGS. 1-10 except that there is a flexible flap 83 connecting the edge of two of the pairs of connecting pairs of edges. Like reference numerals in FIGS. 16 and 17 refer to like reference numerals used in the FIGS. 1-10.

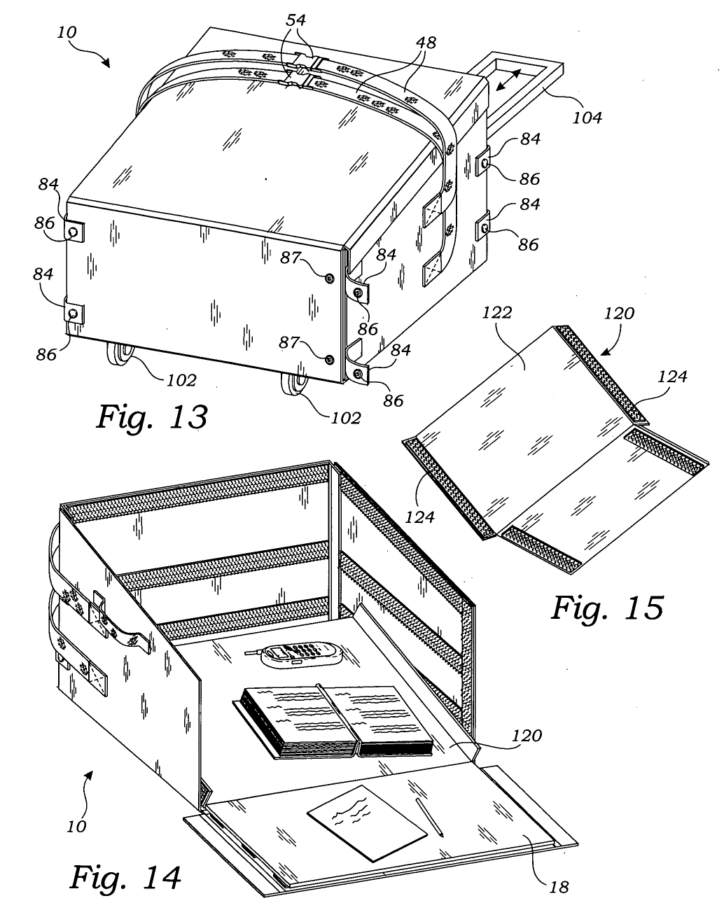

The container 10 is easily assembled or disassembled as follows. FIG. 11 shows the container 10 in the fully assembled configuration, with the top cover 28 in the closed position. To disassemble and collapse the container 10, the top cover 28 is opened. Then, the fasteners 86 and the buckle 54 are all unfastened. The fasteners 82 between each of the respective adjoining walls are unfastened and the right wall 16 and left wall 20 are then folded inward and relatively flat onto the bottom panel 12, as shown in FIG. 13. The front wall 18 is then folded onto the folded right and left walls 16 and 20. Finally, the back wall 22 is folded onto the front wall 18 with the top cover 28 extended. The top cover 28 folds around the bottom panel 12 and the fastener 29 is attached to the fastener 31 to hold the container 10 in the folded configuration. The straps 54 may be placed inside the folded container 10 at any convenient point in the disassembly and folding procedure, for example, after the right wall 18 and left wall 20 are folded inward. The container 10 is unfolded and assembled by simply reversing the steps described above for disassembling and collapsing the container 10.

Turning to FIGS. 12-13, several additional features of the container of the present invention will be described. The container 10 may have a pair of wheels 102 and a handle 104 so that the container 10 can be pulled like a luggage cart. The wheels 102 and handle 104 may be retractable so that they are out of the way when the container 10 is placed in a vehicle.

The use of the container 10 and container 10 is basically the same, and therefore, the use of the container will be described with reference to the container 10. It should be understood that the use of the container 10 is essentially the same. The objects to be transported in the container 10 may be secured in the container before or after the container 10 is placed into the vehicle. The object is placed into the container 10 and is set onto the bottom panel 12 or on a removable shelf 110, if a shelf is being utilized. In order to firmly secure the object, the object is preferably placed against the sidewall 14. An adjustable divider, such as divider 32 or divider 50, is placed into the container 10 on the side of the object opposite the portion of the sidewall 14 against which the object was placed. The divider 32 or 50 is then secured in placed by attaching the fasteners 40 to the fasteners 26. By biasing the divider 32 or 50 against the object, the object can be very securely held in place within the container 10.

The container 10 is secured in the vehicle using the straps 48. The container 10 is placed onto a vehicle seat. With the buckles 54 released, the straps are looped around the back of the seat, and then the buckles are fastened. The length of the straps 48 may be adjusted to tighten the straps 48 to firmly secure the container 60 to the seat. It should be understood that the straps 48 may be secured to other structure within the vehicle, such as the dash or door handles.

The container 10 may also be used as a desk as shown in FIG. 14. The front wall 18 is unfastened from the adjoining walls 16 and 20 and the front wall 11 is folded outward. A desk attachment 120 is placed into the container 10 at any comfortable angle. As shown in FIG. 15, the desk attachment 120 has a flat panel 122 and a strip of hook and loop fasteners 124 are disposed on both side edges of the flat panel 122. The fasteners 124 are removably attachable to the strips of hook and loop fasteners 26 on the inside surface of the sidewall 14. The hook and loop fasteners 124 may be foldably attached to the side edges of the desk attachment 32 so that they can be aligned to effectively attach to the hook and loop fasteners 26. The foldability of the fasteners 124 may be accomplished by disposing the fasteners on a flexible flap of material which extends from the edge of the flat panel 122.

Of course, in use of the container 10, any of the other accessories and features such as the hanging pocket 70, hanger board 90, cup holder 60, or removable shelf 110 may be utilized. It is to be understood that all of the accessories and optional features shown with respect to either container 10 or container 81 are equally applicable to the other container.

While the present invention has been fully described above with particularity and detail in connection with what is presently deemed to be the invention, it will be apparent to those of ordinary skill in the art that many modifications thereof may be made without departing from the principles and concepts set forth herein. Hence, the proper scope of the present invention should be determined only by the broadest interpretation of the appended claims so as to encompass all such modifications and equivalents.

What is claimed is:

1. A container for use in a vehicle, the container comprising:
a bottom panel;
a plurality of walls foldably attached to and extending upwardly from said bottom panel, said walls and bottom together defining a first container portion, each of said walls having an inside surface, an outside surface and an edge around a perimeter of each of said walls, each wall having a plurality of wall fasteners along at least a portion of the edge of said wall for removably coupling to at least a portion of the edge of an adjoining wall;
a divider between at least two of said walls to divide the first container portion into second and third container portions, a plurality of divider fasteners disposed on the inside surface of said at least two walls for being removably attached to said divider, said divider fasteners being arranged such that the divider may be adjusted to a plurality of positions within said first container portion; and
wherein each of said walls may be folded from an extended position in which each of said walls extends upwardly from said bottom panel, to a collapsed position in which each of said walls is folded into a position substantially parallel to said bottom panel.

2. The container of claim 1 wherein said portion of the edge of an adjoining wall has a plurality of mating wall fasteners which removably couple to said wall fasteners.

3. The container of claim 1 wherein said divider has a plurality of mating divider fasteners which removably couple to said divider fasteners.

4. The container of claim 1 wherein said wall fasteners comprise hook and loop fasteners mounted on a flap disposed along said at least a portion of the edge of said wall.

5. The container of claim 2 wherein said mating wall fasteners comprise hook and loop fasteners.

6. The container of claim 1 wherein said divider fasteners comprise hook and loop fasteners.

7. The container of claim 1 further comprising:
a strap having first and second ends, said first end attached to the outside surface of one of said walls and said second end having a strap fastener, said strap fastener being removably attachable to a wall adjoining said one of said walls.

8. The container of claim 7 further comprising a mating strap fastener disposed on the outside surface of said wall adjoining said wall to which said first end of said strap is attached, said mating strap fastener being removably attachable to said strap fastener.

9. The container of claim 1 wherein said plurality of divider fasteners comprises a strip of hook and loop fasteners which extends across substantially the entire length of said walls.

10. The container of claim 1 wherein said plurality of divider fasteners comprises a plurality of strips of hook and loop fasteners which extend across substantially the entire length of the inside surface of said walls, said strips being arranged in horizontal rows across said inside surface of said walls.

11. The container of claim 1 further comprising a securing strap, said securing strap comprising first and second ends, said first end attached to one of said walls and said second end attached to on the other of said walls, said strap being adjustable and detachable such that it can be securely fastened around a vehicle seat to hold said container in place.

12. The container of claim 1 further comprising a top panel foldably attached to an upper edge of one of said walls.

13. The container of claim 1 further comprising a receptacle attached to the outside surface of one of said walls, said receptacle having an opening at its upper end for receiving an item to be held in said receptacle.

14. The container of claim 13 wherein said receptacle is configured to securely hold a drink container.

15. The container of claim 14 wherein said drink container is a standard twelve ounce soft drink can.

16. The container of claim 13 wherein said receptacle is configured to securely hold a cellular phone.

17. The container of claim 1 wherein said divider is oriented substantially vertically within said first container portion.

18. The container of claim 1 wherein said divider is oriented substantially horizontally within said first container portion.

19. The container of claim 1 wherein said divider further comprises a receptacle attached to a surface of said divider, said receptacle having an opening at its upper end for receiving an item to be held in said receptacle

20. The container of claim 1 further comprising a first receptacle attached to the outside surface of one of said walls, said first receptacle having an opening at its upper end for receiving an item to be held in said first receptacle and wherein said divider comprises a second receptacle attached to a surface of said divider, said second receptacle having an opening at its upper end for receiving an item to be held in said second receptacle.

21. A method of securing an object in a container for transport in a vehicle, the method comprising the steps of:
placing the object in the container, the container having a bottom panel and a sidewall extending upwardly from said bottom panel, said bottom panel and sidewall together defining a first container portion;
placing a divider into the container, the divider extending between at least two different positions of said sidewall and dividing the first container portion into second and third container portions; and
securing said divider into place by fastening the divider to fasteners disposed on an inside surface of said sidewall.

22. A method of disassembling and collapsing a container used for transporting objects in a vehicle, said container comprising a plurality of walls foldably attached to and extending upwardly from a bottom panel, said walls and bottom together defining a first container portion, each of said walls having an inside surface, an outside surface and an edge around a perimeter of each of said walls, each wall having a plurality of wall fasteners along at least a portion of the edge of said wall for removably coupling to at least a portion of the edge of an adjoining wall, the method comprising the steps of:
unfastening said plurality of wall fasteners; and
folding each of said walls inward such that said walls are stacked relatively flat over said bottom panel.

23. A container for use in a vehicle, the container comprising:
a bottom panel;
a sidewall attached to and extending upwardly from the bottom panel, said sidewall and bottom together defining a first container portion, said sidewall having an inside surface, an outside surface;
a divider extending between at least different positions on the inside surface of said sidewall and dividing the first container portion into second and third container portions; and
a plurality of divider fasteners disposed on the inside surface of said sidewall for being removably attached to said divider, said divider fasteners being arranged such that the divider may be adjusted to a plurality of positions within said first container portion

24. The container of claim 23 wherein said sidewall comprises a plurality of walls foldably attached to and extending upwardly from said bottom panel, said walls having an inside surface, an outside surface and an edge around the perimeter, each wall having a plurality of wall fasteners along at least a portion of the edge of said wall for removably coupling to at least a portion of the edge of an adjoining wall, wherein each of said walls may be folded from an extended position in which each of said walls extends upwardly from said bottom panel, to a collapsed position in which each of said walls is folded into a position substantially parallel to said bottom panel.
